(19) United States
(12) Patent Application Publication
(10) Pub. No.: US 2008/0285436 A1
(43) Pub. Date: Nov. 20, 2008

(54) Methods, systems, and computer program products for providing site redundancy in a geo-diverse communications network

(75) Inventor: Benjamin C. Robinson, Raleigh, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Tekelec

(21) Appl. No.: 11/803,681

(22) Filed: May 15, 2007

(51) Int. Cl. H04J 3/14; H04L 12/66

(52) U.S. Cl. 370/217; 370/401; 714/2

(57) ABSTRACT

Methods, systems, and computer program products for providing an enriched messaging service in a communications network is described. In one embodiment, the system includes a first host operating in an active state at a first site in a communications network and a second host operating in a standby state at a second site in the communications network. The system also includes a first proxy located at the second site, wherein the first proxy is adapted to receive an original message addressed to a virtual Internet protocol (VIP) address associated with the first and second hosts to identify the first host as being in the active state, and, in response, to encapsulate the original message in at least one Internet protocol (IP) packet to form a tunneled message that includes the VIP address. The first proxy is also responsible for forwarding the tunneled message to the first site.

### TECHNICAL FIELD

The subject matter described herein relates to providing site and component redundancy in a communications network. More particularly, the subject matter described herein relates to methods, systems, and computer program products for providing site redundancy in a geo-diverse communications network.

### BACKGROUND

Communications networks, such as telecommunications signaling networks, including IP multimedia subsystem (IMS) networks, provide critical operations for establishing and maintaining communications between users. Consequently, there is an expectation in the industry that any service provider that offers a commercial grade telecommunications service is capable of providing a certain reliability. One way a service provider can improve reliability is by ensuring certain site and component redundancy measures are implemented throughout the system.

In particular, a service provider can establish redundancy measures by placing redundant network components at separate geographic sites so as to avoid any localized catastrophe (e.g., a hurricane, a widespread blackout, etc.). One manner in which redundant measures may be implemented is to position each of a pair of related servers at two geo-diverse sites (i.e., two sites that are geographically separated). Notably, one server acts as an active server while the other server functions as a backup or a standby server. By positioning the active server and the standby server at separate sites, various network problems may be avoided. For example, if the active server is rendered inoperable for any reason, then the corresponding standby server initiates a failover procedure and assumes the role as the active server.

One possible solution to providing geo-diverse redundancy is to connect geo-diverse redundant nodes to the same LAN or layer 2 connection. However, layer 2 is a data link layer and cannot be easily extended over great distances. Namely, it is extremely cost prohibitive to provide layer 2 connectivity between nodes separated by large geographic distances. Specifically, specialized layer 2 hardware components would have to be utilized to form a suitable network connection, such as a layer 2 tunnel. For example, an extended layer 2 network would employ a considerable amount of Ethernet lines (e.g., 1000+miles). Thus, from a bandwidth and equipment standpoint, it would be difficult and expensive to implement a tunnel that can function as a physical LAN connection.

Another possible solution to providing geo-diverse redundancy is to connect geo-diverse redundant nodes using a layer 3 protocol, such as IP. Such a solution may be desirable because network hardware that is already in place may be utilized. However, if an IP protocol is utilized for connecting geo-diverse redundant nodes and the nodes share an IP address, network traffic would be sent to both sites based on geographic proximity of the sending nodes to each site. For example, nodes closer to the standby site would send IP traffic destined to the site to the standby site whereas IP traffic destined to the site from nodes closer to the active site would arrive at the active site. In order for such an architecture to function, the active site must know that it is the active site, the standby site must know that it is the standby site, the active site must process all traffic when active, and the standby site must forward traffic to the active site when operating as standby. Because IP routers are stateless, additional functionality must be added to meet the requirements for layer 3 geo-redundancy.

Accordingly, there exists a need for improved methods, systems, and computer program products for providing site redundancy in a communications network.

### SUMMARY

According to one aspect, the subject matter described herein comprises methods, systems, and computer program products for providing site redundancy in a geo-diverse communications network. One system includes a first host operating in an active state at a first site in a communications network and a second host operating in a standby state at a second site in the communications network. The system also includes a first proxy located at the second site, wherein the first proxy is adapted to receive an original message addressed to a virtual Internet protocol (VIP) address associated with the first and second hosts to identify the first host as being in the active state, and, in response, to encapsulate the original message in at least one Internet protocol (IP) packet to form a tunneled message that includes the VIP address. The first proxy is also responsible for forwarding the tunneled message to the first site.

The subject matter described herein for providing site redundancy may be implemented using a computer program product comprising computer executable instructions embodied in a computer readable medium. Exemplary computer readable media suitable for implementing the subject matter described herein includes disk memory devices, programmable logic devices, application specific integrated circuits, and downloadable electrical signals. In addition, a computer readable medium that implements the subject matter described herein may be distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1 is an exemplary communications network utilizing component and site redundancy measures at two geo-diverse network locations according to an embodiment of the subject matter described herein;

FIG. 2 is a flow chart illustrating exemplary steps for transferring a message in a geo-diverse communications network according to an embodiment of the subject matter described herein; and

FIG. 3 is a flow chart illustrating exemplary steps for providing heartbeat messages according to an embodiment of the subject matter described herein.

### DETAILED DESCRIPTION

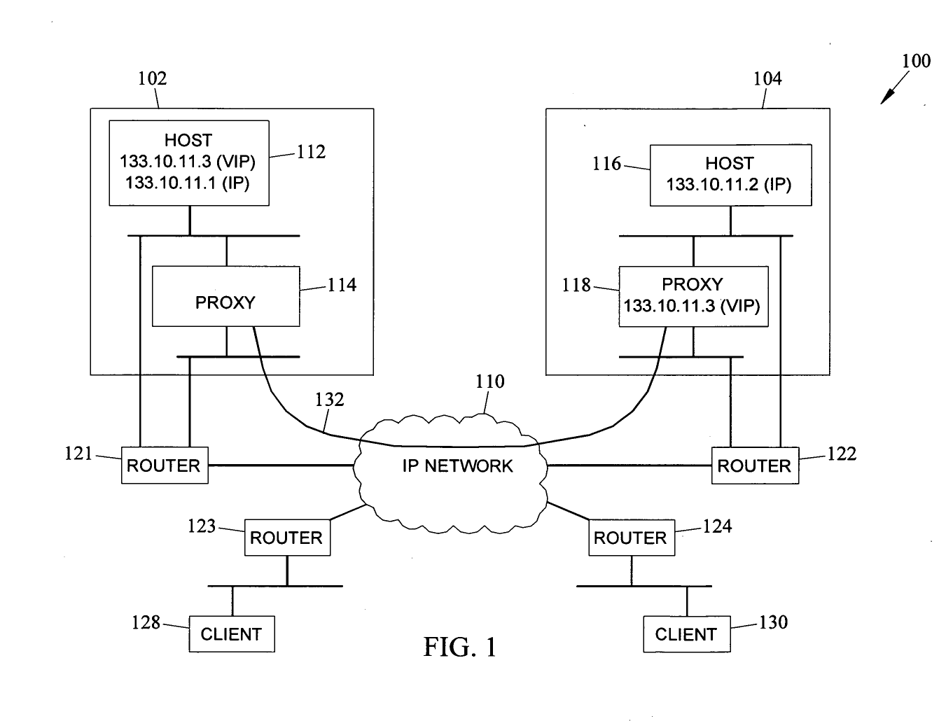

The present subject matter relates to systems and methods for providing site redundancy across a geo-diverse communications system. FIG. 1 illustrates an exemplary communications system 100 in which the present subject matter may be implemented according to an embodiment of the subject matter described herein.

Referring to FIG. 1, system 100 may include a first network site 102, a second network site 104, an Internet Protocol (IP) communications network 110, a plurality of routers 121-124, client 128, and client 130. Network site 102 and network site 104 are geo-diverse sites that are geographically distinct and may be separated by a considerable distance (e.g., 1000 miles). In one embodiment, site 102 and site 104 share the same IP address, which is referred to herein as a virtual IP address or VIP. In one embodiment, host 112 and host 116 form an active and standby pair that may be used to provide a network operator with a desirable level of redundancy. In one embodiment, certain protocols may be used to initially assign the active and standby hosts. Some programs, such as Linux HA, are utilized to provide a virtualized server, which includes an active/standby pair, e.g., an active host 112 and a standby host 116. Linux HA accomplishes the server virtualization via a virtual IP address (VIP) and a heartbeat mechanism, which establishes and maintains the active/standby states, which will be discussed in more detail below.

Notably, host 112 and host 116 are replicated hosts that are separately located. Furthermore, site redundancy requires that each of host 112 and host 116 be provisioned with both hardware and network bandwidth capacity to handle cumulative needs of both the individual sites (i.e., there must be spare resources to each site to handle a site failure scenario).

First network site 102 may include host 112 and a proxy 114. In one embodiment, host 112 and proxy 114 may each be a computer, a server, or any like network component. Host 112 may include a network interface card (NIC) or other like network adapter that is identified by a media access control (MAC) address. The host's MAC address (e.g., the MAC address of the host's NIC) may correspond to a network address, such as an IP address (e.g., 133.10.11.1). In addition, the host's MAC address may also correspond to a virtual IP (VIP) address (if the host is operating in an active state) that is used in conjunction with the present subject matter. For example, host 112 may be designated as the active host (i.e., the VIP owner) of system 100. More specifically, host 112 is assigned a VIP address by a network operator (e.g., via Linux HA) that enables host 112 to act as the sole active host for both the active site 102 and standby site 104.

Similarly, second network site 104 is a second separate IP network that may include a similar host 116 and proxy 118. In one embodiment, first network site 102 and second network site 104 compose a single LAN by sharing the same IP address and may be connected by a virtual IP-in-IP tunnel 132 that spans between proxy 114 and proxy 118. Namely, proxy 114 and proxy 118 may be used to establish a dedicated layer 3 (IP) connection between network 102 and network 104. In one embodiment, tunnel 132 facilitates the communication of packets from client devices received at site 104 to be ultimately forwarded to active host 112 (e.g., the tunnel 132 may be used to transport VIP traffic intended for the “active” host that arrives as the “standby” site.

Proxy 114 may include any network device that is capable of receiving or intercepting ARP request messages intended for a host. In one embodiment, proxy 114 is able to receive broadcasted ARP messages, which may be sent to site 102 inquiring about host 116 (if host 116 is the active host). Proxy 118 may also include any network device that is capable of receiving or intercepting ARP requests intended for a host. In one embodiment, proxy 118 is able to receive a broadcasted ARP message sent to site 104 inquiring about host 112 (if host 112 is the active host). Address Resolution Protocol (ARP) is a protocol that enables a proxy server to reply to ARP request messages on behalf of another host server. For example, proxy 118 may also be configured to act as the active proxy for host 112 by sharing a common VIP address. Notably, the sharing of the VIP address enables host 112 to effectively function as the host of site 104 despite being located at a geo-diverse site (e.g., site 102). For example, proxy 118 (located in network 104) may be configured to receive ARP request messages intended for host 112 that are addressed to the VIP address. In one embodiment, proxy 114 and proxy 118 may each be a Geo Blade server.

In one embodiment, proxy 114 and proxy 118 may be used to create an IP-in-IP tunnel (e.g., tunnel 132). IP-in-IP tunneling involves two tunnel endpoints. For example, the tunnel endpoints may include proxy 114 and proxy 118. In one embodiment, one tunnel endpoint “encapsulates” the IP traffic that is to be tunneled. Namely, the tunneled IP packet to be sent would include a tunneled IP header and tunneled payload data. Moreover, the tunneled payload data itself may be made up of an IP packet including an IP header and normal payload data. The other tunnel endpoint (e.g., the far-end tunnel endpoint) is responsible for “de-encapsulating” the received tunneled IP packet and forwards the IP tunneled payload data (i.e., the IP packet that was tunneled) to the site's host server (e.g., host 112).

In one embodiment, tunnel 132 acts as a medium for the exchange of heartbeat status messages between host 112 and host 116 (via proxy 114 and proxy 118). Heartbeat status messages (e.g., heartbeat request and reply messages) may include user datagram protocol (UDP) uni-cast packets. In one embodiment, the transfer of heartbeat messages may be possible by implementing Linux HA in system 100. Linux HA is an open source project that may be used to provide flexibility in high availability (HA) networks. Linux HA utilizes heartbeat messages that are sent at regular intervals between an active node and standby node. When heartbeat mechanism is initially configured, an active host (e.g., host 112) is selected. When the heartbeat mechanism is initiated, the active host sets up an interface for a virtual IP (VIP) address, which may be accessed by external end users (e.g., client 130). If the active host fails, then a backup or standby host (e.g., standby host 116) in the system 100 will start up an interface for the VIP address and utilize ARP to ensure that all traffic bound for the VIP address is received by the new active host (and its proxy at the other site). In the event the former active host comes online or becomes available again, resources failover again (e.g., from host 116 back to host 112) so they are controlled by the original active host. In one embodiment, the former active host (i.e., host 112) assumes the role of the standby host when it becomes available again. Specifically, host 116 continues to function as the active host and host 112 begins sending heartbeat request messages to host 116 in its role as the standby host.

Each VIP address is considered to be a resource. In one embodiment, resources are encapsulated as programs that work similarly to UNIX init scripts. Namely, the resource can be started and stopped, and can be queried to ascertain if it is operating properly. Thus, heartbeat is able to start and stop resources depending on the status of the active host that it is communicating with via the use of a heartbeat protocol.

In one embodiment, heartbeat messages are utilized by the communication system 100 for enabling host 112 to inform host 116 that host 112 is functioning properly, and vice versa. More specifically, it enables an active host (i.e., the host at a designate active site) to inform a host at a standby site that it is still operational (i.e., has not failed).

In one embodiment, if a standby host does not receive a certain number of heartbeat messages after a certain amount of time (i.e., the number of heartbeat messages threshold and elapsed time threshold may be configured by a network operator), then the standby host may initiate a failover procedure and becomes the active host. For example, the standby host (e.g., host 116) may send a heartbeat request message to the active host (e.g., host 112). The standby host is expecting the recipient of the heartbeat request (i.e., the active host) to respond with a heartbeat reply message. Failure of the active host may be defined by the standby host to occur if the standby host does not receive a consecutive number of heartbeat reply messages from the active host. For example, if a predefined heartbeat sending interval is set to 500 ms and a predefined failure threshold is set to 3, then the following exemplary scenario defines failure for the active host at site 102. Host 116 at standby site 106 sends a heartbeat request message to host 112. If 500 ms elapse and a heartbeat reply message is not received, then host 116 registers a “miss.” Host 116 subsequently sends a second heartbeat request and if another 500 ms elapses and a heartbeat reply message is not received (i.e., 2 consecutive misses), then a second miss is registered. Afterwards, host 116 sends a third heartbeat request message to host 112. If another 500 ms elapses and no heartbeat reply received (i.e., 3 consecutive misses), then host 116 determines that host 112 has failed, initiates a failover operation, and becomes the “new” active host.

Because host 112 and host 116 are replicas (i.e., the standby host frequently replicates the active host's files), the failover process is seamless and the system 100 may resume functioning with little, if any, down time. In one embodiment, heartbeat messages may be sent over both serial links and Ethernet interfaces.

Referring back to FIG. 1, routers 121-124 may include any routing or switching devices that are configured to receive and forward packets between networks. In one embodiment, a router may utilize at least one internal routing table to determine how each received packet may be forwarded. For example, the destination address included in a received packet may indicate which interface or port the router may forward the packet to.

In one embodiment, router 121 and router 122 may be configured to utilize an address resolution protocol (ARP). In this context, ARP may be used to “map” network addresses (e.g., IP addresses) to corresponding physical addresses (e.g., a MAC addresses). In one embodiment, ARP can be used to acquire a layer 2 address by using a requested corresponding layer 3 address. Referring to FIG. 1, router 121 (or router 122) may broadcast an ARP request onto a network (e.g., IP network site 102 or 104) which includes the IP address of the target node (e.g., host 112 or 116) the router wishes to communicate with. The node with the address responds by sending back an ARP reply message that includes its hardware address. Using this hardware address, packets can be transmitted from the router to the target node. Although FIG. 1 depicts four routers, any number of routers may be employed without departing from the scope of the present subject matter.

Client device 128 and client device 130 may include a desktop computer, laptop computer, or any like device which enables a client to transmit packets to the system 100. Although FIG. 1 only depicts two client devices, any number of clients may be served by the present subject matter.

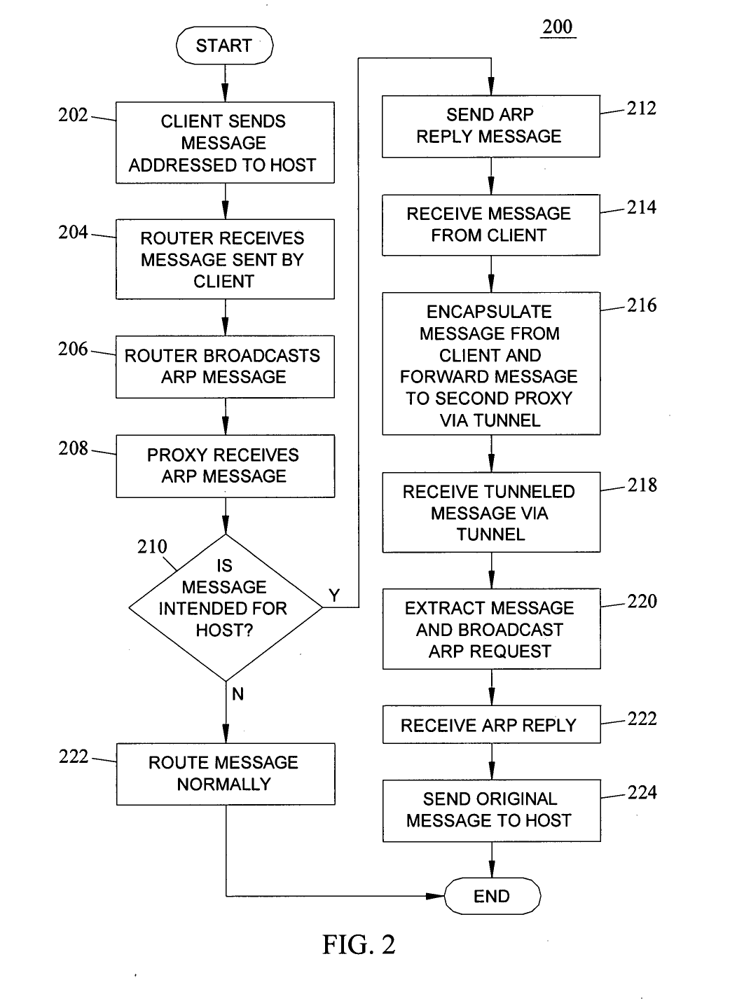

In one embodiment, host server 112 is capable of receiving a message from a client (e.g., client 130) that is initially received at a related geo-diverse site (e.g., site 104). This process is depicted in FIG. 2, which is a flow chart illustrating the exemplary steps of a method 200 for transferring messages in geo-diverse communications system 100 according to an embodiment of the subject matter described herein. Namely, method 200 shows the transferring of traffic data received at a standby site to the active site (using proxies, ARP, and IP-in-IP tunneling). In block 202, a client device transmits a message intended for a host server located in a geo-diverse site. In one embodiment, client 130 located near site 104 wishes to send an original message to host 112, which is located at active site 102. Specifically, the message (e.g., at least one IP packet) is addressed with the VIP address (e.g., 133.10.11.3) associated with host 112 and host 116 (although only one host actively supports the VIP address at one time).

In block 204, the message is received by a router that is local to the sending client. In one embodiment, the message from client 130 is initially received by router 122. Notably, router 122 is more apt to receive the message from client 130 (as opposed to, e.g., router 121) due to its proximity to client 130 (i.e., in accordance to “shortest route” routing protocols).

In block 206, the receiving router broadcasts an address resolution protocol (ARP) message. In one embodiment, router 122 does not know the physical MAC address that corresponds to the VIP address (e.g., 133.10.11.3) specified by client 130, and thus, cannot properly forward the message. However, router 122 does possess information regarding the proper local area network (LAN) associated with the addressed VIP address (because router 122 may inspect the network portion of the VIP address (e.g., 133.10.X.X). Consequently, router 122 may broadcast an ARP message to the network node (i.e., at VIP address 133.10.X.X) in order to locate the appropriate server or network device (i.e., host) indicated by the original message sent by client 130.

In block 208, the ARP message is received. In one embodiment, proxy 118 receives the ARP message broadcasted from router 122 because proxy 118 shares the VIP address with the active host 112 and active host 112 does not reside at site 104.

In block 210, a determination is made as to whether the message is searching for a host server in a geo-diverse site. In one embodiment, proxy 118 inspects the ARP message and ascertains if the ARP message is requesting the physical address for host server 112. If so, then method 200 proceeds to block 212. Otherwise, method 200 continues to block 222 where the message is routed in accordance to normal routing protocol procedure.

In block 212, an ARP reply message is sent. In one embodiment, proxy 118 sends back an ARP reply message to router 122 indicating that the proper MAC address for host 112 is its own MAC address. Specifically, proxy 118 “poses” as host 112 and notifies router 122 that it is the intended destination (i.e., it proxies for host 112) and all further communications to host 112 should be sent to the MAC address of proxy 118. Proxy 118 may be configured in this manner if it has been designated as the proxy server at the standby site for host 112 (i.e., host 112 has been designated as the “active” host). In one embodiment, proxy 118 may be configured to act as a proxy for host 112 by being assigned the VIP address (e.g., 133.10.11.3) that is shared with, and tied to the physical address of, host 112. Consequently, all subsequent messages or IP packets intended for host 112 from router 122 will be delivered to proxy server 118.

In block 214, the original message from the client is received. In one embodiment, proxy 118 receives the message originally sent from client 130 via router 122. For example, after receiving the ARP reply and being notified that proxy 118 is the proper destination, router 122 forwards the original message from client 130 to proxy 118 (which, from the view point of router 122, is host 112) in an Ethernet packet stream.

In block 216, the original message is encapsulated and forwarded to a second proxy server via an IP-in-IP tunnel. In one embodiment, the original message from client 130 is encapsulated and sent to proxy server 114 via IP-in-IP tunnel 132 as a tunneled message through the IP network. The message is encapsulated in a manner in which the payload of the original message and the VIP address of host server 112 collectively make up the payload of the message to be tunneled. The header of the tunneled message includes the IP address of proxy 114.

In block 218, the tunneled message is received via the IP-in-IP tunnel. In one embodiment, proxy 114 receives the tunneled message transmitted from proxy 118 via the dedicated IP-in-IP tunnel 132.

In block 220, the message extracted and an ARP request message is sent. In one embodiment, proxy 114 extracts the payload from the tunneled message and broadcasts an ARP request message in an attempt to try to locate the physical address that corresponds to the VIP address in the tunneled message's payload. Notably, the payload of the tunneled message includes an IP header, which is addressed to the VIP of host 112, and a payload section, which includes the original message sent from client 130.

In block 222, an ARP reply message is received. In one embodiment, an ARP reply message is sent from host 112 (as a response for receiving the broadcasted ARP request message) and is received by proxy 114. In block 224, the original message is sent to intended host 112. Method 200 then ends. In an alternate embodiment, client 128 may send a message, which is addressed to the VIP address, intended for host 112. Although the same VIP network address may be used at both site 102 and site 104 (i.e., network portion of IP address), a router that is nearer to one particular site tends to send the message to the nearest site because of shortest path first routing protocols.

In this scenario, the message from client 128 is received by router 121 instead of router 122 due to the proximity of client 128 to router 121 and to shortest path routing protocols that are commonly employed by networks. Router 121 then broadcasts an ARP request message to site 102 that is received by host 112. Host 112 directly receives the ARP request message because it is the only component at site 102 that is actively associated (i.e., host 112 is in the active state) with the VIP address. Host 112 subsequently sends an ARP reply message to router 121 that includes the physical (e.g., MAC) address of host 112. Router 121 then forwards the original message from client 128 to host 112. Notably, both proxy 114 and tunnel 132 are not needed in this situation because the message is forwarded to site 102 and active host 112 is able to directly receive the message.

In order for the present subject matter to function properly, the sites 102 and 104 must be allowed to communicate with each other in order to coordinate which site will act as the active or standby site. In one embodiment, Linux HA protocols may be used to enable a network operator or the hosts to elect an active and standby site. When heartbeat messages are exchanged between sites, the IP addresses of the hosts are used (e.g., 133.10.11.1 for site 102 and 133.10.11.2 for site 104) as opposed to using VIP addresses.

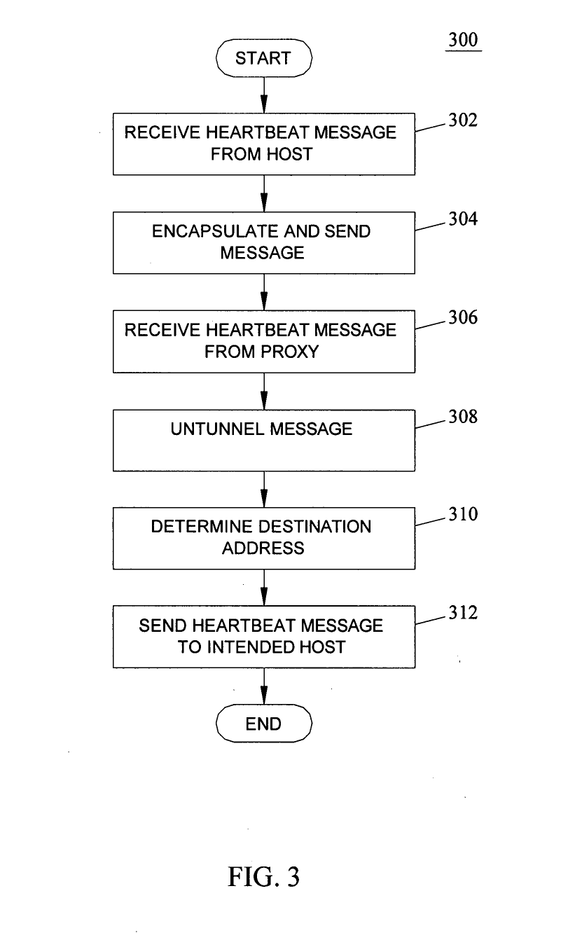

In one embodiment, host 112 is capable of communicating with a host 116 via heartbeat messages. This heartbeat communication allows for the coordination of the active and standby statuses of host 112 and host 116. An exemplary process demonstrating this communication is depicted in FIG. 3. Notably, FIG. 3 which is a flow chart that illustrates the exemplary steps for communicating heartbeat messages according to an embodiment of the subject matter described herein. In block 302, a heartbeat message is received. In one embodiment, proxy 114 receives a heartbeat message from host 112. The heartbeat message is received as an encapsulated Ethernet message addressed to the IP address of host 116. Proxy 114 receives the message since it is acting as a proxy for host 116.

In block 304, the heartbeat message is encapsulated. In one embodiment, proxy 114 encapsulates the heartbeat message in a tunneled IP packet message addressed to proxy 118. Proxy 114 subsequently sends the tunneled message to proxy 118 via tunnel 132. Specifically, proxy 114 places the heartbeat message packet (i.e., host IP header and heartbeat payload) into the payload of the tunneled message. Similarly, the header of the tunneled message may be the IP address of proxy 118.

In block 306, the tunneled message is received. In one embodiment, proxy 118 receives the tunneled message from proxy 114 via IP-in-IP tunnel 132.

In block 308, the heartbeat message is untunneled. In one embodiment, proxy 118 extracts the payload from the tunneled message. As previously mentioned, the extracted payload may include a header addressed to host 116 and a payload section that contains the heartbeat data.

In block 310, a destination address is determined. In one embodiment, proxy 118 inspects the payload of the tunneled message for an IP address. Notably, proxy 118 may broadcast an ARP request (which includes the IP address) that is received by host 116. Proxy 118 subsequently receives an ARP reply message from host 116 along with its physical address. In an alternate embodiment, proxy 118 may access an ARP cache (not shown) to obtain the physical address of host 116 using the IP address in the payload of the tunneled message.

In block 312, the heartbeat message is sent. In one embodiment, proxy 118 forwards the heartbeat message to host 116 using the physical (e.g., MAC) address obtained in block 310. The method 300 then ends. After receiving the heartbeat message, host 116 is capable of ascertaining that host 112 is functioning properly. At this time, host 116 may respond by sending a heartbeat reply message to host 112. The heartbeat reply message may be sent to host 112 in a similar manner described above.

The present subject matter is configured to failover in the event the active host no longer functions for any reason (e.g., a natural disaster, unexpected maintenance, an accident, etc.). In one embodiment, the failure of the active site is indicated by the suspension of the transmission of heartbeat messages from the active host. For example, designated standby host 116 at the standby site 104 fails to receive a predetermined number of heartbeat messages over the span of a predefined period of time (e.g., three heartbeat messages in 0.5 seconds). Notably, the amount of time and the number of messages may be configured to meet the requirements of system 100. In one embodiment, the Linux HA application initiates the failover procedure.

Once standby host 116 determines that active host 112 has failed, a failover process is initiated and host 116 assumes the role as active host. Similarly, proxy 114 becomes the proxy for the active host and proxy 118 then becomes the proxy for the new standby host (i.e., host 112). Notably, proxy 114 and host 116 become actively associated (i.e., host 116 enters the active state) with the VIP address and proxy 118 deletes the VIP address. Host 112 failed so it effectively is no longer actively associated with the VIP address. The failover procedure is easily performed since host 112 and site 116 have been maintained in a manner so that the two hosts are replicas.

In one embodiment, communication between the proxies is needed to coordinate the failover process. That is, for Layer-3 geo-diversity to operate properly, the proxies at each site must be aware of relevant state information at the active and standby sites (i.e., so that each proxy knows what to proxy and when to act as a proxy for a given host at the alternate site). Specifically, a proxy server must be aware of the state (e.g., active or standby) of the host at its site (i.e., proxy site state). For example, referring to FIG. 1, proxy 114 must be aware of the state of host 112 at site 102 and proxy 118 must be aware of the state of host 116 at site 104. Similarly, a proxy must share this site state information with its peer proxy (proxy-to-proxy state). For instance, proxy 114 must share its site state (for site 102) with proxy 118 and vice versa.

Site state data may be obtained by a proxy via a “polling” process, i.e., sending a request to the host at the site to learn the host's “state.” Notably, there are at least three possible states that may exist. First, the host is “not present” at the site where it is assigned to be. For example, host 112 is not at site 102 (e.g., host 112 failed). Second, the host is an “active” host. That is, the host is present and is the “active” host of the “active/standby” pair (e.g., host 112 is “active” at site 102). Third, the host is a “standby” host. Namely, the host is present and is the “standby” host of the “active/standby” pair (e.g., host 116 is “standby” at site 104).

In one embodiment, the proxy may “poll” on a configurable time interval and a failure threshold may also be specified. The host may require logic in order to both receive and reply to the poll. For example, a 250 ms poll interval with a failure threshold of “2” means that the proxy polls the host every 250 ms, and if the host does not respond for two consecutive polls then the proxy considers the host as “not present” on the second consecutive fail. Otherwise, the host remains in its current state (i.e., either “active” or “standby”).

When the hosts at both sites are “present,” the site status information provides sufficient data to allow the proxy at the site to know what to proxy for. That is, if host 112 at site 102 is reporting that it is “active,” then proxy 114 knows that it should not be the proxy for VIP currently associated with host 112. At site 104, proxy 118 acknowledges that host 116 is in a “standby” state. Based on this information, proxy 118 knows to act as proxy for the VIP. By proxying for the VIP at site 104, IP packets arriving at site 104 destined to the VIP are able to be tunneled to site 102 and delivered to host 112. This is the “no failure” case (i.e., host 112 and host 116 are both functioning properly).

Conversely, there are various failure cases that require that the proxy hosts at the two sites share status information (e.g., proxy-to-proxy status information). A first case includes the scenario where a host at a site fails (i.e. host 112 at site 102 enters the “host not present” state). Alternatively, this case may also include the situation where both hosts enter this state contemporaneously. If a host enters the “host not present” state, then the host at the alternate site becomes both the new “active” host and the VIP owner. The proxy at the site where the host entered the “host not present” state in this scenario begins to proxy for the VIP. IP traffic destined for the VIP is then tunneled to the alternate site and the new “active” host (e.g., host 116). This is the desired behavior unless the host at the alternate site is also in a “host not present” state. If the host at the alternate site is also in a “host not present” state, then VIP traffic is not tunneled to the alternate site. To achieve this behavior, the proxy must know the state of the alternate site via the proxy at that site (i.e. the two sites must share their respective site status with one another).

A second case includes an instance where the IP connectivity between the two sites fails. This scenario may occur if the path through the Internet that is providing IP connectivity for the IP tunnel fails and no alternate path is available. The loss of IP connectivity between the two sites places the active/standby host relationship into a “split brain” state. A “split brain” state is when each of the two hosts believes it should become the “active” host, thus resulting in two active hosts (i.e., one at each site). In this scenario, the proxy at each site should not have the VIP as a proxy host. Namely, the proxy should not be proxying for any IP hosts while the IP tunnel is not operational. As soon as the IP tunnel becomes operational, the proxy at each site should begin proxying for the host at the alternate site (e.g. proxy 114 should be proxying for host 116 at site 104 and vice versa). The proxies should also begin exchanging site status data so that the VIP can also be proxied. This behavior allows the two hosts to re-establish an active/standby state (i.e. leave the “split brain” state and return to an active/standby state).

Each proxy will be configured to send a “site-to-site” status update at a specific interval if the IP tunnel is operational. The site-to-site proxy state exchange may occur on a periodic interval (e.g., every 200 ms). The proxy at either site may initiate the process by sending the first “site-to-site” status message. The receiving proxy at the alternate responds with a “site-to-site” status message, thereby providing its site status to the alternate site proxy. This technique results in “site-to-site” messages being exchanged based on the lowest interval time being configured at the two sites.

To better illustrate the aforementioned scenarios, Table 1 depicts the states of host 112 at site 102, host 116 at site 104, and the operational state of the IP tunnel. Similarly, Table 1 illustrates what the proxy at each specific site will be VIP proxying based on the state transitions (i.e., FROM TO changes and the tunnel operation state). This state table is not meant to be exhaustive, but is intended to reflect the prior discussion with respect to the proxy behavior in conjunction with the hosts and tunnel state.

TABLE 1
Host and Site State Table

| Site 102 | | | | | Site 104 | | | |
|---|---|---|---|---|---|---|---|---|
| Host 112 (IP-1) | | | | | | Host 116 (IP-2) | | |
| | | Not | Proxy | | Proxy | | | Not |
| Active | Standby | Present | 114 | IP Tunnel State | 118 | Active | Standby | Present |
| X | | | IP-2 | OPERATIONAL | IP-1 | | X | |
| | | | | | VIP | | | |
| X | | | IP-2 | OPERATIONAL | IP-1 | | FROM | TO |
| | | | | | VIP | | X | X |
| FROM | TO | | IP-2 | OPERATIONAL | IP-1 | TO | FROM | |
| X | X | | VIP | | | X | X | |
| TO | FROM | | IP-2 | OPERATIONAL | IP-1 | FROM | | TO |
| X | X | | | | VIP | X | | X |
| FROM | FROM | TO | IP-2 | OPERATIONAL | IP-1 | TO | FROM | FROM |
| X | X | X | VIP | | | X | X | X |
| TO | FROM | FROM | | TUNNEL FAILS | | TO | FROM | FROM |
| X | X | X | | | | X | X | X |
| FROM | FROM | TO | | TUNNEL FAILS | | FROM | FROM | TO |
| X | X | X | | | | X | X | X |

In one embodiment, the first and second hosts may comprise telecommunications network nodes. More specifically, the first and second hosts may include IP multimedia subsystem (IMS) nodes that are capable of performing various call session control functions (CSCF). Notably, the nodes may each implement a proxy CSCF (P-CSCF), an interrogating CSCF (I-CSCF), and/or a serving CSCF (S-CSCF) as described in commonly-assigned U.S. patent application Ser. No. 11/584,247, the disclosure of which is incorporated herein by reference in its entirety.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A system for transferring a message in a geo-diverse communications network, the system comprising:
a first host operating in an active state at a first site in a communications network;
a second host operating in a standby state at a second site in the communications network; and
a first proxy located at the second site, wherein the first proxy is adapted to receive an original message addressed to a virtual Internet protocol (VIP) address associated with the first and second hosts to identify the first host as being in the active state, and, in response, to encapsulate the original message in at least one Internet protocol (IP) packet to form a tunneled message that includes the VIP address, and forward the tunneled message to the first site.

2. The system of claim 1 comprising a second proxy located at the first site, wherein the second proxy is adapted to receive the tunneled message from the first proxy, extract the original message from the tunneled message, determine the physical address of the first host using the VIP address, and forward the original message to the first host using the determined physical address.

3. The system of claim 2, wherein the encapsulated message is forwarded to the second proxy via an IP-in-IP tunnel.

4. The system of claim 2, wherein the physical address comprises a media access control (MAC) address.

5. The system of claim 2, wherein the first proxy receives a first address resolution protocol (ARP) request broadcast message that includes the VIP address from a router requesting the physical address of the first host.

6. The system of claim 5, wherein the first proxy responds to the first ARP request broadcast message by sending a first ARP reply message that includes a media access control (MAC) address of the first proxy.

7. The system of claim 6, wherein the first proxy receives the original message from the router.

8. The system of claim 1, wherein the first site and the second site are located in geographically separate locations.

9. The system of claim 1, wherein the second host is a replica of the first host.

10. The system of claim 2, wherein the first host receives an address resolution protocol (ARP) request message that includes the VIP address from the second proxy.

11. The system of claim 10, wherein the first host responds to the ARP request message by sending a reply message that includes the physical address of the first host to the second proxy.

12. The system of claim 1 wherein the first and second hosts comprise IP multimedia subsystem (IMS) hosts.

13. A system for transferring a message in a geo-diverse communications network, the system comprising:
a first host operating in an active state at a first site in a communications network, wherein the first host is associated with a virtual Internet protocol (VIP) address;
a second host operating in a standby state at a second site in the communications network; and
a first proxy located at the first site, wherein the first proxy is adapted to receive a heartbeat message from the first host addressed to the second host, encapsulate the heartbeat message in at least one Internet protocol (IP) packet to form a tunneled message, and forward the tunneled message to the second site.

14. The system of claim 13 comprising a second proxy, which is associated with the VIP address and located at the second site, wherein the second proxy is adapted to receive the tunneled message from the first proxy, extract the heartbeat message from the tunneled message, determine the physical address of the second host, and forward the heartbeat message to the second host using the determined physical address.

15. The system of claim 13 wherein the first and second hosts comprise telecommunications network nodes.

16. The system of claim 13 wherein the telecommunications network nodes comprise IP multimedia subsystem (IMS) nodes.

17. The system of claim 13, wherein the heartbeat message comprises a user datagram protocol (UDP) message.

18. The system of claim 13, wherein the heartbeat message comprises a heartbeat request message.

19. The system of claim 13, wherein the second host initiates a failover process if a predefined number of heartbeat reply messages is not received from the first host during a predefined period of time in response to a respective predefined number of heartbeat request messages sent from the second host.

20. The system of claim 19, wherein the second host operates in the active state when the failover process is initiated.

21. The system of claim 20, wherein each of the second host and the second proxy becomes associated with the VIP address and each of the first host and the first proxy become disassociated from the VIP address.

22. The system of claim 13, wherein the physical address is received from the second host in an address resolution protocol (ARP) reply message in response to an ARP request message broadcasted by the second proxy.

23. The system of claim 13, wherein the physical address is determined by the second proxy querying an address resolution protocol (ARP) cache.

24. A method for transferring a message in a geo-diverse communications network, the method comprising steps of:
receiving, at a standby site, an original message addressed to a virtual Internet protocol (VIP) address that is associated with an active host that is located at an active site;
encapsulating the original message in at least one Internet protocol (IP) packet to form a tunneled message that includes the VIP address;
forwarding the tunneled message to the active site; and
extracting, at the active site, the original message from the tunneled message;
determining the physical address of the active host using the VIP address; and
forwarding the original message to the active host using the determined physical address.

25. The method of claim 24, wherein the encapsulated message is forwarded from a first proxy at the standby site to a second proxy at the active site via an IP-in-IP tunnel.

26. The method of claim 24, wherein the physical address comprises a media access control (MAC) address.

27. The method of claim 24, wherein the first proxy receives a first address resolution protocol (ARP) request message that includes the VIP address from a router requesting the physical address of the active host.

28. The method of claim 27, wherein the first proxy responds to the first ARP request broadcast message by sending a first ARP reply message that includes the MAC address of the first proxy to the router.

29. The method of claim 28, wherein the first proxy receives the original message from the router.

30. The method of claim 24, wherein the active site and the standby site share the VIP address.

31. The method of claim 24, wherein the active site and the standby site are positioned in separate locations.

32. The method of claim 24, wherein the active host receives an address resolution protocol (ARP) request message that includes the VIP address from the second proxy.

33. The method of claim 32, wherein the active host responds to the ARP request message by sending an ARP reply message that includes the physical address of the active host to the second proxy.

34. The method of claim 24 wherein the active host comprises an IP multimedia subsystem (IMS) node.

35. A method for providing redundancy in a geo-diverse communications network, the method comprising steps of:
receiving, at a first proxy located at a first site, a heartbeat message from a first host operating located at the first site, wherein the heartbeat message is addressed to a second host that is located at a second site;
encapsulating the heartbeat message in at least one Internet protocol (IP) packet to form a tunneled message that includes the IP address of the second host;
forwarding the tunneled message to a second proxy located at the second site; and
extracting, at the second proxy, the heartbeat message from the tunneled message;
determining the physical address of the second host using the IP address; and
forwarding the heartbeat message to the second host using the determined physical address.

36. The method of claim 35, wherein the heartbeat message comprises a user datagram protocol (UDP) message.

37. The method of claim 35, wherein the heartbeat message comprises a heartbeat request message.

38. The method of claim 35, wherein the first host is operating in an active state and shares a virtual IP (VIP) address with the second proxy.

39. The method of claim 38, wherein the second host initiates a failover process if a predefined number of heartbeat reply messages is not received from the first host during a predefined period of time in response to a respective predefined number of heartbeat request messages sent from the second host.

40. The method of claim 39, wherein the second host operates in the active state when the failover process in initiated.

41. The method of claim 40, wherein each of the second host and the first proxy becomes associated with the VIP address and each of the first host and the second proxy become disassociated from the VIP address.

42. The method of claim 35, wherein the physical address is received from the second host in an address resolution protocol (ARP) reply message in response to an ARP request message broadcasted by the second proxy.

43. The method of claim 35, wherein the physical address is determined by the second proxy querying an address resolution protocol (ARP) cache.

44. The method of claim 35 wherein the active host comprises and IP multimedia subsystem (IMS) host.

45. A computer program product comprising computer executable instructions embodied in a computer readable medium for performing steps comprising:
receiving, at a standby site, an original message addressed to a virtual Internet protocol (VIP) address that is associated with an active host that is located at an active site;
encapsulating the original message in at least one Internet protocol (IP) packet to form a tunneled message that includes the VIP address;
forwarding the tunneled message to the active site; and
extracting, at the active site, the original message from the tunneled message;
determining the physical address of the active host using the VIP address; and
forwarding the original message to the active host using the determined physical address.
